(19) United States
(12) Patent Application Publication
(10) Pub. No.: US 2015/0245266 A1
(43) Pub. Date: Aug. 27, 2015

(54) APPARATUS AND METHOD TO EXPEDITE AN INTER RADIO ACCESS TECHNOLOGY RESELECTION

(71) Applicant: QUALCOMM Incorporated, San Diego, CA (US)

(72) Inventors: Kuo-Chun Lee, San Diego, CA (US); Daniel Amerga, San Diego, CA (US); Sohn Paul Gatlin, San Diego, CA (US); Shian-De Ju, San Diego, CA (US); Shailesh Maheshwari, San Diego, CA (US); Arnaud Meylan, San Diego, CA (US); Arvind Vardarajan Santhanam, San Diego, CA (US); Jack Shyh-Hurng Shauh, San Diego, CA (US); Sivaramakrishna Veerepalli, San Diego, CA (US); Jun Wang, Poway, CA (US); Suli Zhao, San Diego, CA (US)

(21) Appl. No.: 14/336,125

(22) Filed: Jul. 21, 2014

Related U.S. Application Data
(60) Provisional application No. 61/942,809, filed on Feb. 21, 2014.

(51) Int. Cl. H04W 36/16

(52) U.S. Cl. CPC H04W 36/16; H04W 36/36

(57) ABSTRACT

Various aspects directed towards expediting an inter-RAT (radio access technology) reselection are disclosed. A user equipment (UE) operates according to a first RAT and utilizes an evolved multimedia broadcast multicast service (eMBMS) via the first RAT. A second RAT, which is unable to support eMBMS, is selected such that operation of the UE transitions from the first RAT to the second RAT. A reselection of the first RAT is then expedited by modifying at least one of a dormancy timer value initialization, a reselection timer value initialization, or a frequency priority.

### CROSS-REFERENCE TO RELATED APPLICATIONS

This application claims priority to and the benefit of provisional patent application No. 61/942,809, filed in the United States Patent and Trademark Office on Feb. 21, 2014, the entire content of which is incorporated herein by reference.

### TECHNICAL FIELD

Aspects of the present disclosure relate generally to wireless communication systems, and more particularly, to expediting an inter-RAT (radio access technology) reselection from a system that does not support evolved multimedia broadcast multicast service (eMBMS) to a system that supports eMBMS.

### BACKGROUND

Wireless communication networks are widely deployed to provide various communication services such as telephony, video, data, messaging, broadcasts, and so on. Such networks, which are usually multiple access networks, support communications for multiple users by sharing the available network resources.

Generally, some suitably configured wireless mobile equipment (called a mobile station (MS), user equipment (UE), access terminal (AT), etc. in various literature) can reselect between cells configured for different types of radio access technologies. Reselecting between disparate systems, however, does not occur instantaneously. This delay in reselecting between systems (e.g., reselecting from a system configured according to cdma2000 standards (also called 1xRTT or simply 1x) or according to Evolution-Data Optimized (EV-DO) standards (also called high rate packet data or HRPD), to a system configured according to evolved UMTS terrestrial radio access network (e-UTRA), also called long-term evolution or LTE standards) may undesirably delay UE access to particular services provided by such systems. Accordingly, an expedited mechanism for reselecting between disparate systems is desired.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Aspects of the present disclosure provide methods, apparatuses, computer program products, and processing systems directed towards expediting an inter-RAT (radio access technology) reselection. In one aspect, the disclosure provides a method, which includes operating a user equipment (UE) according to a first RAT in which the operating comprises utilizing an evolved multimedia broadcast multicast service (eMBMS) via the first RAT. The method further includes selecting a second RAT, which is unable to support eMBMS, such that operation of the UE transitions from the first RAT to the second RAT. A reselection of the first RAT is then expedited by modifying at least one of a dormancy timer value initialization, a reselection timer value initialization, or a frequency priority.

In another aspect, a device comprising various circuits is disclosed, which is configured to facilitate UE transitions between a first RAT, which supports eMBMS, and a second RAT, which is unable to support eMBMS. The device includes a first circuit configured to operate a UE according to the first RAT, and a second circuit configured to operate the UE according to the second RAT. An expediting circuit is also included, which is configured to expedite a reselection of the first RAT by modifying at least one of a dormancy timer value initialization, a reselection timer value initialization, or a frequency priority.

In a further aspect, another device is disclosed. Here, the device comprises means for operating a UE according to a first RAT in which the means for operating comprises means for utilizing an eMBMS via the first RAT. The device further includes means for selecting a second RAT, which is unable to support eMBMS, such that operation of the UE transitions from the first RAT to the second RAT. Means for expediting a reselection of the first RAT is also provided, which includes means for modifying at least one of a dormancy timer value initialization, a reselection timer value initialization, or a frequency priority.

In yet another aspect, a non-transitory machine-readable storage medium having one or more instructions stored thereon is disclosed. Here, when executed by at least one processor, the one or more instructions cause the at least one processor to operate a UE according to a first RAT in which the UE utilizes an eMBMS via the first RAT. The instructions further comprises instructions to select a second RAT, which is unable to support eMBMS, such that operation of the UE transitions from the first RAT to the second RAT. A reselection of the first RAT is then expedited via instructions to expedite, which include instructions to modify at least one of a dormancy timer value initialization, a reselection timer value initialization, or a frequency priority.

These and other disclosed aspects will become more fully understood upon a review of the detailed description, which follows. Other aspects, features, and aspects of the present invention will become apparent to those of ordinary skill in the art, upon reviewing the following description of specific, exemplary aspects of the present invention in conjunction with the accompanying figures. While features of the present invention may be discussed relative to certain aspects and figures below, all aspects of the present invention can include one or more of the advantageous features discussed herein. In other words, while one or more aspects may be discussed as having certain advantageous features, one or more of such features may also be used in accordance with the various aspects of the invention discussed herein. In similar fashion, while exemplary aspects may be discussed below as device, system, or method aspects it should be understood that such exemplary aspects can be implemented in various devices, systems, and methods.

### BRIEF DESCRIPTION OF THE DRAWINGS

FIG. 1 is an exemplary illustration of a UE operating via a first RAT in accordance with an aspect of the disclosure.

FIG. 2 is an illustration of the UE shown in FIG. 1 operating via a second RAT in accordance with an aspect of the disclosure.

FIG. 3 is an illustration of the UE shown in FIG. 2 performing an exemplary inter-RAT reselection in accordance with an aspect of the disclosure.

FIG. 4 is a block diagram illustrating an example of a hardware implementation for a user equipment employing a processing system according to some aspects of the disclosure.

FIG. 5 is a block diagram illustrating exemplary expediting components according to an aspect of the disclosure.

FIG. 6 is a flow chart illustrating a first exemplary inter-RAT reselection procedure according to some aspects of the disclosure.

FIG. 7 is a flow chart illustrating a second exemplary inter-RAT reselection procedure according to some aspects of the disclosure.

FIG. 8 is a flow chart illustrating a third exemplary inter-RAT reselection procedure according to some aspects of the disclosure.

FIG. 9 is a conceptual block diagram illustrating a wireless device capable of being operated in an E-UTRA network and an HRPD network.

FIG. 10 is a conceptual block diagram illustrating a wireless device capable of being operated in an E-UTRA network and a 1xRTT network.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

A multimedia broadcast multicast service (MBMS) is a frequently used communication protocol for wireless networks, which provides for efficient broadcast and multicast of media streams to wireless users, in forms such as audio/video programming. When implemented in a long-term evolution (LTE) network, such a system is commonly called an evolved MBMS (eMBMS). In various scenarios, however, user equipment (UE) is often redirected or handed over from the LTE network to another network, such as a code division multiple access (CDMA) network, which lacks support for eMBMS. For instance, such scenario may arise when a UE moves around a service area, when there is congestion on an LTE network, or when a user wishes to initiate a voice call while connected to an LTE network that does not support voice calls. Thus, if a user is utilizing eMBMS (e.g., watching a streaming program), under various scenarios the user may lose their eMBMS service. While this loss of eMBMS for a short period (e.g., for the duration of a voice call) may be acceptable and even expected, it can sometimes take quite a long time for the UE to return to the LTE network where it can resume the eMBMS service. Accordingly, aspects disclosed herein are directed towards expediting an inter-RAT (radio access technology) reselection from a system that does not support eMBMS (e.g., a CDMA network) to a system that supports eMBMS (e.g., an LTE network) so that a UE can quickly resume eMBMS.

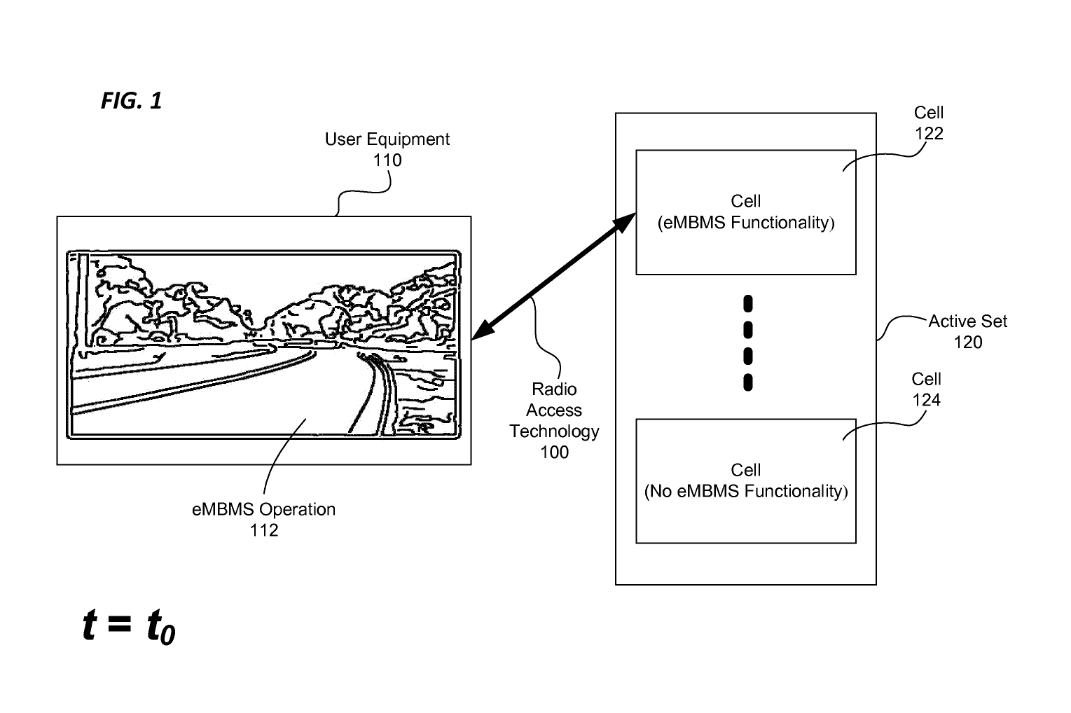

An overview of various disclosed aspects for expediting such inter-RAT reselection is now described with reference to FIGS. 1-3. As illustrated in FIG. 1, an active set 120 for a UE 110 may comprise a plurality of cells including, for example, cell 122 and cell 124. For this scenario, it is assumed that cell 122 supports eMBMS (e.g., an LTE network cell), whereas cell 124 does not support eMBMS (e.g., a CDMA network cell). As illustrated, FIG. 1 illustrates an operation of UE 110 at time t=t₀, wherein eMBMS operation 112 (e.g., streaming video of a movie) is supported by cell 122 via RAT 100 (e.g., an LTE system).

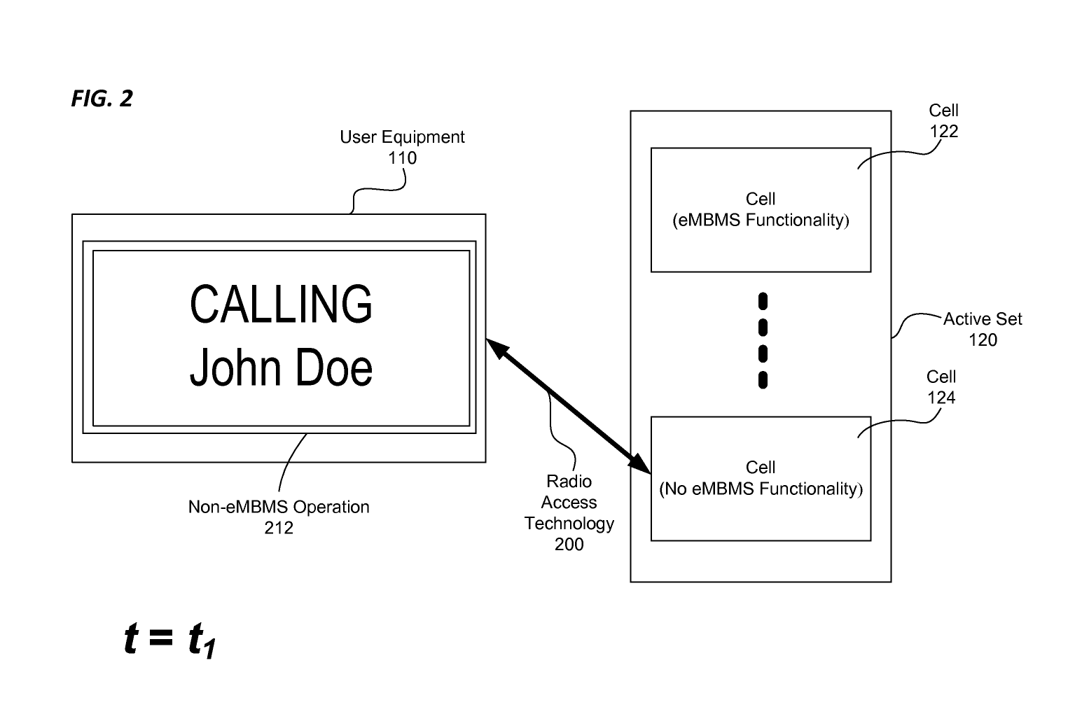

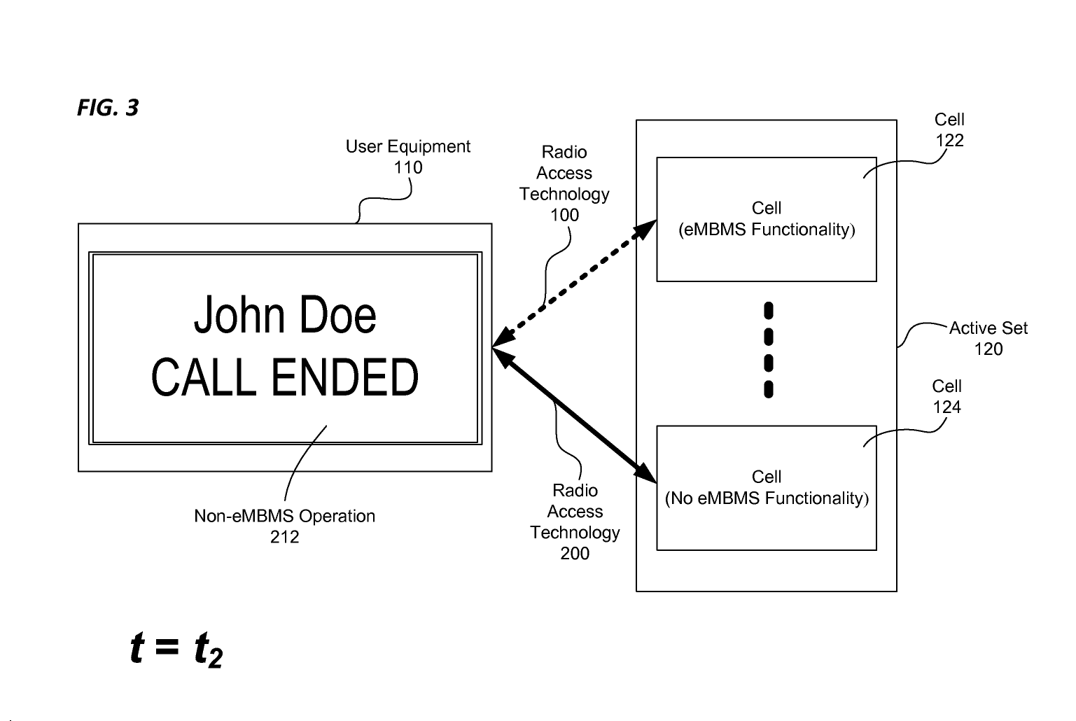

For this scenario, however, it is assumed that RAT 100 does not support voice calls. Therefore, if the user then wishes to make a voice call, UE 110 must select a cell from active set 120 that supports voice calls. In FIG. 2, for instance, upon initiating a voice call at t=t₁ (where t₀<t₁), UE 110 selects cell 124, wherein the voice call is a non-eMBMS operation 212 supported by cell 124 via RAT 200 (e.g., a CDMA system). Once the call ends, however, it would be desirable for UE 110 to resume eMBMS operation 112 (i.e., resume streaming a movie) with minimal delay. In FIG. 3, for instance, upon ending the voice call at t=t₂ (where t₁<t₂), it would be desirable for UE 110 to quickly reselect cell 122 (or another cell in active set 120 that supports eMBMS), so that eMBMS operation 112 may again be supported by cell 122 via RAT 100 (e.g., an LTE system).

In order to expedite the reselection of RAT 100 illustrated in FIG. 3, various solutions are disclosed. For instance, it is contemplated that such expediting may be achieved by reducing a dormancy timer, such as the dormancy timer used in the HRPD and 1xRTT protocols. That is, after data transmission via RAT 200 ends, and there is no data transmission for the duration of another dormancy timer, it is contemplated that UE 110 can initiate a connection release or connection close procedure. Here, if the eMBMS application is still launched, or if eMBMS middleware is enabled, UE 110 can use a reduced timer value to more quickly close the connection or send a Release Order.

In another contemplated solution, a reselection timer may be reduced. Indeed, to begin a reselection procedure, UE 110 may need to run a timer called “EUTRAReselectTime,” which is random and uniformly distributed in the range of [0, 2^{N}] seconds, where N is configured in the HRPD OtherRATNeighborList message, or the 1xRTT Alternative Technologies Information message. According to the aspects disclosed herein, inter-RAT reselection is expedited by reducing the value of this reselection timer. For instance, if the eMBMS application is still launched, or the eMBMS middleware is enabled, UE 110 can be configured to overwrite its EUTRAReselectTimer and set it to zero or a very small value.

In yet another contemplated solution, a higher eMBMS frequency priority may be used. That is, when UE 110 receives an HRPD OtherRATNeighborList message, or a 1xRTT Alternative Technologies Information message, this message can configure the EARFCNPriority of the LTE frequencies, and the ServingPriority of the 1xRTT/HRPD network. Here, if the eMBMS application is still launched, or if the eMBMS middleware is enabled, UE 110 can be configured to overwrite its EARFCNPriority and prioritize the LTE eMBMS frequency as its highest priority. It is contemplated that prioritizing the eMBMS frequency may be performed by UE 110 or the network. For instance, the 1xRTT/HRPD network can set the LTE frequency of eMBMS as its highest priority for reselections. Alternatively, if the network does not send the HRPD OtherRATNeighborList message or the 1xRTT Alternative Technologies Information message, then UE 110 may be configured to cache a recent eMBMS frequency to return immediately to the eMBMS frequency, provided that the middleware is still enabled or the eMBMS application is still launched.

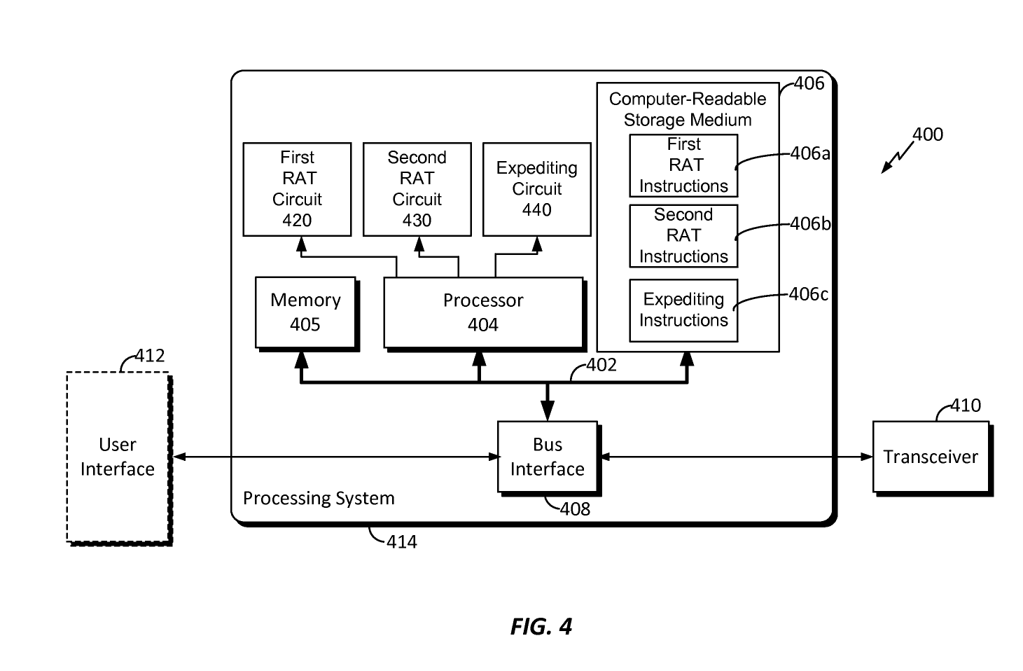

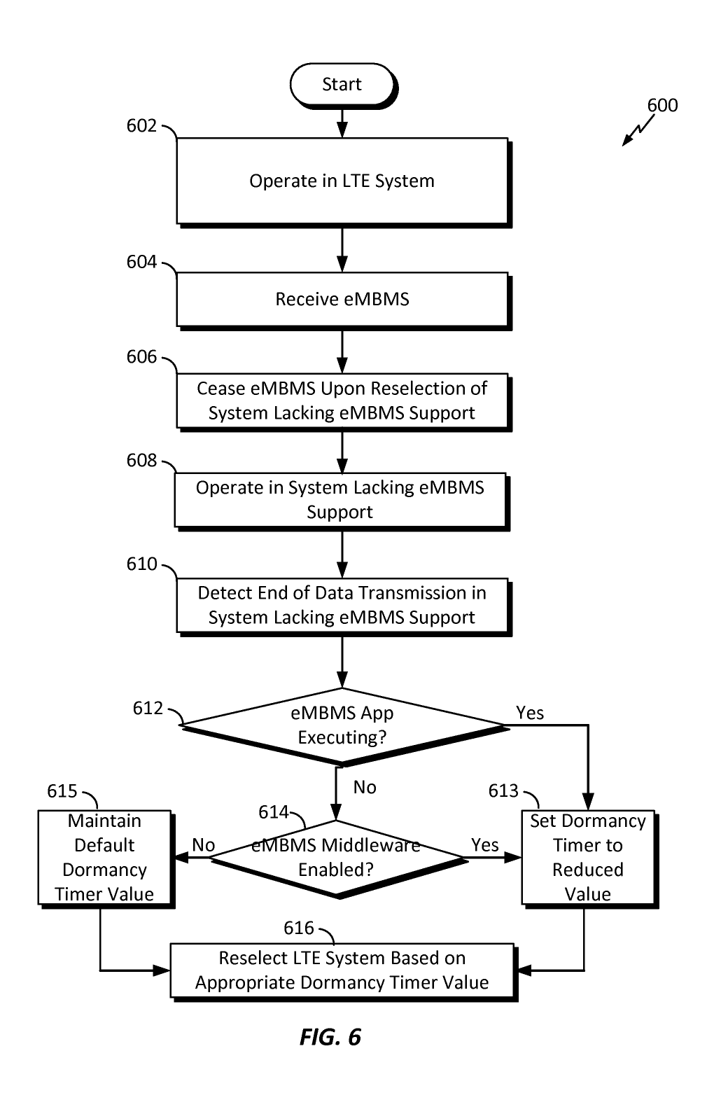

Referring next to FIG. 4 is a conceptual diagram illustrating an example of a hardware implementation for a user equipment (UE) 400 employing a processing system 414, wherein UE 400 may be a UE as illustrated or described with reference to any one or more of FIGS. 1-10. In accordance with various aspects of the disclosure, an element, or any portion of an element, or any combination of elements may be implemented with a processing system 414 that includes one or more processors 404. Examples of processors 404 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. That is, the processor 404, as utilized in UE 400, may be used to implement any one or more of the processes described below and illustrated in FIGS. 6-8.

In this example, the processing system 414 may be implemented with a bus architecture, represented generally by the bus 402. The bus 402 may include any number of interconnecting buses and bridges depending on the specific application of the processing system 414 and the overall design constraints. The bus 402 links together various circuits including one or more processors (represented generally by the processor 404), a memory 405, and computer-readable media (represented generally by the computer-readable medium 406). The bus 402 may also link various other circuits such as timing sources, peripherals, voltage regulators, and power management circuits, which are well known in the art, and therefore, will not be described any further. A bus interface 408 provides an interface between the bus 402 and a transceiver 410. The transceiver 410 provides a means for communicating with various other apparatus over a transmission medium. Depending upon the nature of the apparatus, a user interface 412 (e.g., keypad, display, speaker, microphone, joystick) may also be provided.

In an aspect of the disclosure, computer-readable medium 406 is configured to include various instructions 406a, 406b, and/or 406c to facilitate expediting a reselection between two different radio access technologies (RATs, referred to herein as an inter-RAT reselection), e.g., from a system that does not support an evolved multimedia broadcast multicast service (eMBMS), such as 1x/DO systems, to a system that supports eMBMS, such as an LTE system, as shown. In a similar aspect, such expediting can instead be implemented via hardware by coupling processor 404 to any of circuits 420, 430, and/or 440, as shown. Here, it is contemplated that the expediting may be performed by any combination of instructions 406a, 406b, and/or 406c, as well as any combination of circuits 420, 430, and/or 440.

It should be appreciated that eMBMS is a feature supported by LTE, which allows LTE eNBs to simultaneously transmit the same media signals to multiple recipients in the same geographic region. As previously stated, the desirability of expediting a reselection from a system that does not support eMBMS (e.g., 1x/DO) to a system that supports eMBMS (e.g., LTE) can be illustrated within the context of various scenarios. For instance, in a first exemplary scenario, UE 400 operates in a congested LTE network where it is either already in a connected mode, or in and idle mode where it needs to set up an LTE connection for sending unicast data. Here, although the LTE network can redirect or handover UE 400 to a 1x/DO network (i.e., a network according to 1xRTT standards, or according to EV-DO standards, also referred to as high-rate packet data or HRPD), such redirection or handover would cause UE 400 to stop receiving eMBMS since eMBMS is not supported by CDMA.

In a second exemplary scenario, UE 400 is again operating in an LTE network. Here, however, it is assumed that UE 400 needs to make a voice call, wherein the LTE network either does not support Voice over LTE (VoLTE) or is too overloaded to allow a VoLTE call. In this scenario, although the LTE network can redirect UE 400 to a 1xRTT network, UE 400 would again stop receiving eMBMS since eMBMS is not supported by 1xRTT.

In each of the above scenarios, UE 400 would thus need to wait until it reselects an LTE network to continue receiving the eMBMS broadcast. However, because such a reselection is not instantaneous, UE 400 will experience a delay in receiving the eMBMS broadcast. Aspects disclosed herein are thus directed towards expediting a reconfiguration of UE 400 to receive an eMBMS broadcast upon reselecting from a system that does not support eMBMS (e.g., 1x/DO) to a system that supports eMBMS (e.g., LTE).

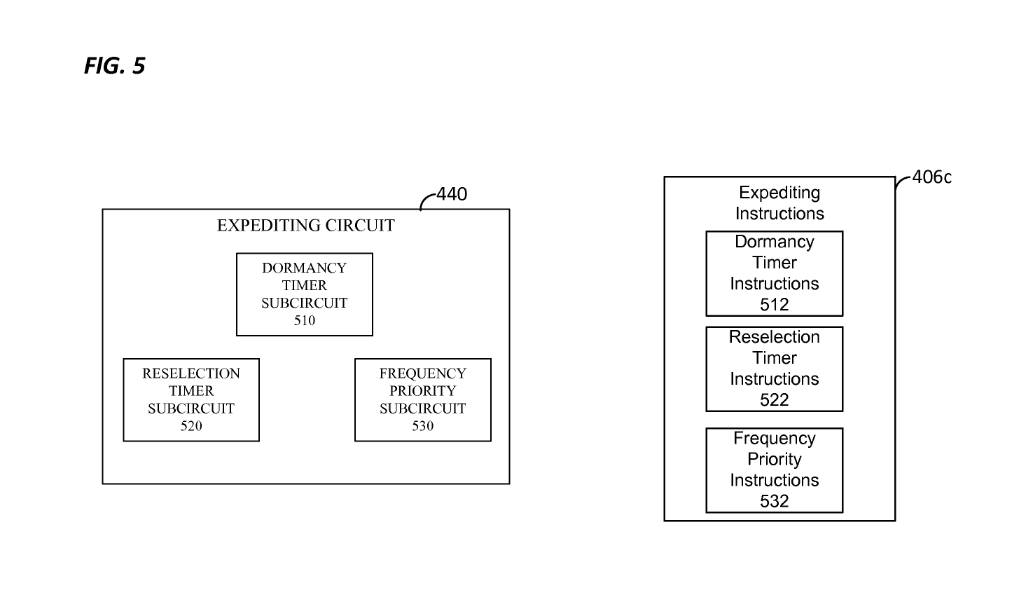

In an aspect of the disclosure, computer-readable medium 406 is thus configured to include various instructions 406a, 406b, and/or 406c to expedite an inter-RAT reselection from a system that does not support eMBMS (e.g., 1x/DO) to a system that supports eMBMS (e.g., LTE), as shown. In a similar aspect, such expediting can instead be implemented via hardware by coupling processor 404 to any of circuits 420, 430, and/or 440, as shown. Moreover, it is contemplated that the enabling may be performed by any combination of instructions 406a, 406b, and/or 406c, as well as any combination of circuits 420, 430, and/or 440. In a particular aspect of the disclosure, instructions 406a and circuit 420 are directed towards operating UE 400 according to a first RAT which supports eMBMS; instructions 406b and circuit 430 are directed towards operating UE 400 according to a second RAT which does not support eMBMS; and instructions 406c and circuit 440 are directed towards expediting a reselection of the first RAT by modifying at least one of a dormancy timer value initialization, a reselection timer value initialization, or a frequency priority, which is discussed in further detail with reference to FIGS. 5-8.

Referring back to the remaining elements of FIG. 4, it should be appreciated that processor 404 is responsible for managing the bus 402 and general processing, including the execution of software stored on the computer-readable medium 406. The software, when executed by the processor 404, causes the processing system 414 to perform the various functions described below for any particular apparatus. The computer-readable medium 406 may also be used for storing data that is manipulated by the processor 404 when executing software.

One or more processors 404 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 406. The computer-readable medium 406 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium 406 may reside in the processing system 414, external to the processing system 414, or distributed across multiple entities including the processing system 414. The computer-readable medium 406 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

Referring next to FIG. 5, it should be appreciated that each of expediting circuit 440 and expediting instructions 406c may facilitate expediting an inter-RAT reselection via any of a plurality of subcomponents. For instance, expediting circuit 440 may comprise dormancy timer sub-circuit 510, reselection timer sub-circuit 520, and frequency priority sub-circuit 530, whereas expediting instructions 406c may comprise dormancy timer instructions 512, reselection timer instructions 522, and frequency priority instructions 532. Here, dormancy timer sub-circuit 510 and dormancy timer instructions 512 are directed towards reducing a dormancy timer value of UE 400 stored in memory 405, since UE 400 cannot initiate a close procedure until the dormancy timer has elapsed. In HRPD, for example, after a data transmission in HRPD ends and there is no data transmission for another dormancy timer, UE 400 will initiate a connection close procedure to release the connection. Similarly, for 1xRTT, after a data transmission in CDMA 1xRTT ends and there is no data transmission for another dormancy timer, UE 400 can initiate a connection release once the dormancy timer has expired. It is contemplated that either of dormancy timer sub-circuit 510 and/or dormancy timer instructions 512 may facilitate reducing a dormancy timer value, relative to a default dormancy timer value, in any of a plurality of ways. For instance, in a particular aspect of the disclosure, such reduction is performed based on a current eMBMS configuration of UE 400. For example, either of dormancy timer sub-circuit 510 and/or dormancy timer instructions 512 may rely on a triggering event to initiate a dormancy timer value reduction procedure, wherein such trigger can comprise detecting that eMBMS middleware is enabled on UE 400 and/or detecting that an eMBMS application is currently launched on UE 400. If properly triggered, either of dormancy timer sub-circuit 510 and/or dormancy timer instructions 512 can then be utilized to reduce the dormancy timer value stored in memory 405 so that the connection to the system that does not support eMBMS (e.g., HRPD, 1xRTT, etc.) closes more quickly relative to having the dormancy timer value set to a lesser default value.

Referring next to FIG. 6, a flowchart illustrating an exemplary procedure 600 for expediting an inter-RAT reselection via reduction of a dormancy timer is provided. In an aspect of the disclosure, procedure 600 may be performed by any UE including, for example, UE 400 via dormancy timer sub-circuit 510 and/or dormancy timer instructions 512. In block 602, the UE operates in an LTE system that supports eMBMS. Procedure 600 then proceeds with the UE receiving an eMBMS broadcast from the LTE network at block 604. At block 606, the UE ceases to receive the eMBMS broadcast upon reselecting a system that does not support eMBMS. As stated previously, this could occur in any of various ways including, for example, the aforementioned scenarios where the UE is redirected to a non-eMBMS network for sending unicast data while in a congested LTE network, or where the UE is similarly redirected because a VoLTE call cannot be supported. The UE thus begins to operate in a non-eMBMS network at block 608. At block 610, the UE then detects that data transmissions have ended in the non-eMBMS network.

Upon detecting that data transmissions have ceased at block 610, the UE then determines whether its dormancy timer value should be set to a reduced value. For this particular example, the UE makes this decision based on a determination at block 612 of whether an eMBMS application is currently executing, and a determination at block 614 of whether eMBMS middleware on the UE is enabled. If either an eMBMS application is currently executing or eMBMS middleware is enabled, procedure 600 proceeds to block 613 where the dormancy timer value is set to a reduced value. Otherwise, if an eMBMS application is not currently executing and eMBMS middleware is not enabled, procedure 600 proceeds to block 615 where the default dormancy timer value is maintained. Procedure 600 then concludes at block 616 where the UE reselects the LTE system, wherein the UE may again receive eMBMS broadcasts, and wherein the dormancy timer elapses according to an initialized value corresponding to either the default value described in block 615 or the reduced value described in block 613.

In another aspect of the disclosure, inter-RAT reselection may also be expedited by reducing a reselection timer value stored in memory 405 via reselection timer sub-circuit 520 and/or reselection timer instructions 522. Namely, since a reselection procedure cannot begin until a reselection timer (e.g., EUTRAReselectTime) has elapsed, reducing the corresponding reselection timer value (e.g., EUTRAReselectTime) would expedite a reselection from a system that does not support eMBMS (e.g., 1x/DO) to a system that supports eMBMS (e.g., LTE). With respect to reducing a EUTRAReselectTime value, for example, it should be noted that the initialization of such value is random and uniformly distributed in the range of [0, 2^{N}] seconds, wherein N is configured according to a received parameter MaxReselectionTimer of the received OtherRATNeighborList message for HRPD systems, and wherein N is configured according to a received parameter MaxReselectionTimer of the received Alternative Technologies Information message for 1xRTT systems. It is contemplated that either of reselection timer sub-circuit 520 and/or reselection timer instructions 522 may facilitate initializing a reselection timer value to a lesser value, relative to a default reselection timer value, in any of a plurality of ways. For instance, in a particular aspect of the disclosure, such reduction is performed based on a current eMBMS configuration of UE 400. For example, either of reselection timer sub-circuit 520 or reselection timer instructions 522 may rely on a triggering event to initiate a reselection timer reduction procedure, wherein such trigger can comprise detecting that eMBMS middleware is enabled on UE 400 and/or detecting that an eMBMS application is currently launched on UE 400. If properly triggered, UE 400 could then utilize either of reselection timer sub-circuit 520 and/or reselection timer instructions 522 to overwrite EUTRAReselectTimer and initialize EUTRAReselectTimer to zero or a very small value, so that the reselection from the system that does not support eMBMS (e.g., HRPD, 1xRTT, etc.) starts more quickly than if a higher default reselection timer value is used.

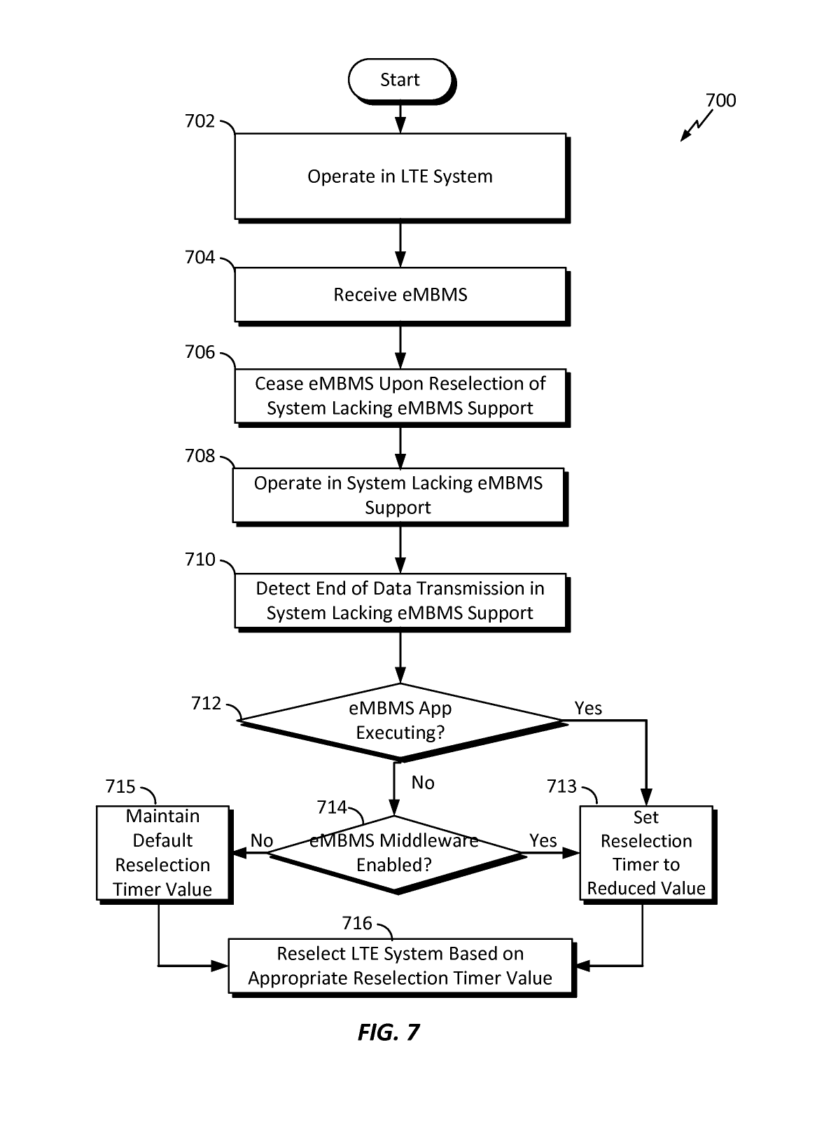

Referring next to FIG. 7, a flowchart illustrating an exemplary procedure 700 for expediting an inter-RAT reselection via reduction of a reselection timer is provided. In an aspect of the disclosure, similar to procedure 600, procedure 700 may be performed by any UE including, for example, UE 400 via reselection timer sub-circuit 520 and/or reselection timer instructions 522. Here, it should also be noted that blocks 702, 704, 706, 708, 710, 712, and 714 of procedure 700 are respectively analogous to blocks 602, 604, 606, 608, 610, 612, and 614 of procedure 600. In procedure 700, however, the UE determines whether a reselection timer value should be modified, rather than a dormancy timer value. Specifically, if the UE determines at block 712 that an eMBMS application is currently executing, or determines at block 714 that eMBMS middleware is enabled, procedure 700 proceeds to block 713 where the reselection timer value is set to a reduced value. Otherwise, if an eMBMS application is not currently executing and eMBMS middleware is not enabled, procedure 700 proceeds to block 715 where the default reselection timer value is maintained. Procedure 700 then concludes at block 716 where the UE reselects the LTE system, wherein the UE may again receive eMBMS broadcasts, and wherein the reselection timer elapses according to an initialized value corresponding to either the default value described in block 715 or the reduced value described in block 713.

In yet another aspect of the disclosure, inter-RAT reselection may also be expedited by elevating a priority of an eMBMS frequency via frequency priority sub-circuit 530 and/or frequency priority instructions 532. To this end, when operating in HRPD, it should be noted that UE 400 can configure EARFCNPriority of the LTE frequencies and HRPD ServingPriority according to a received OtherRATNeighborList message. Similarly, when operating in 1xRTT, UE 400 can configure EARFCNPriority of the LTE frequencies and 1xRTT ServingPriority according to a received Alternative Technologies Information message. Accordingly, in an aspect of the disclosure, the non-eMBMS network (e.g., HRPD, 1xRTT, etc.) can set the LTE frequency of eMBMS as the highest priority. Alternatively, UE 400 itself can set the LTE frequency of eMBMS as the highest priority (e.g., if an OtherRATNeighborList or Alternative Technologies Information message is not provided), wherein the eMBMS frequency used is a cached eMBMS frequency retrieved from memory 405 corresponding to a recently used eMBMS frequency. In either case, prioritizing the eMBMS frequency over other frequencies may again depend on a current eMBMS configuration of UE 400. For example, either of frequency priority sub-circuit 530 or frequency priority instructions 532 may again rely on a triggering event to overwrite EARFCNPriority and prioritize the LTE eMBMS frequency as the highest priority, wherein such trigger can comprise detecting that eMBMS middleware is enabled on UE 400 and/or detecting that an eMBMS application is currently launched on UE 400.

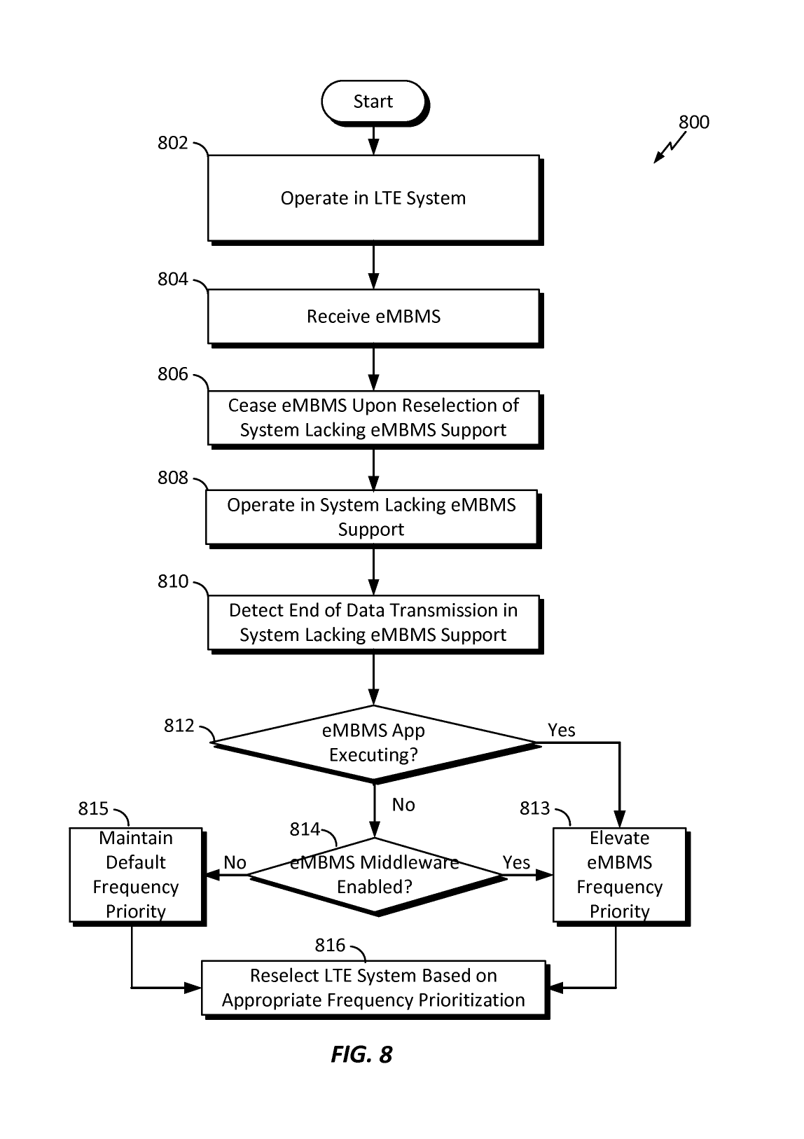

Referring next to FIG. 8, a flowchart illustrating an exemplary procedure 800 for expediting an inter-RAT reselection by elevating a priority of an eMBMS frequency is provided. In an aspect of the disclosure, similar to procedure 600 and procedure 700, procedure 800 may be performed by any UE including, for example, UE 400 via frequency priority sub-circuit 530 and/or frequency priority instructions 532. Here, it should again be noted that blocks 802, 804, 806, 808, 810, 812, and 814 of procedure 800 are respectively analogous to blocks 602, 604, 606, 608, 610, 612, and 614 of procedure 600, and blocks 702, 704, 706, 708, 710, 712, and 714 of procedure 700. In procedure 800, however, the UE determines whether an eMBMS frequency should be prioritized over other non-eMBMS frequencies. Specifically, if the UE determines at block 812 that an eMBMS application is currently executing, or determines at block 814 that eMBMS middleware is enabled, procedure 800 proceeds to block 813 where the eMBMS frequency is prioritized over other non-eMBMS frequencies (e.g., as indicated by the network, or according to a cached eMBMS frequency stored by the UE). Otherwise, if an eMBMS application is not currently executing and eMBMS middleware is not enabled, procedure 800 proceeds to block 815 where the default frequency priority is maintained. Procedure 800 then concludes at block 816 where the UE reselects the LTE system, wherein the UE may again receive eMBMS broadcasts, and wherein frequency is prioritized according to either the default prioritization described in block 815 or the elevated eMBMS prioritization described in block 813.

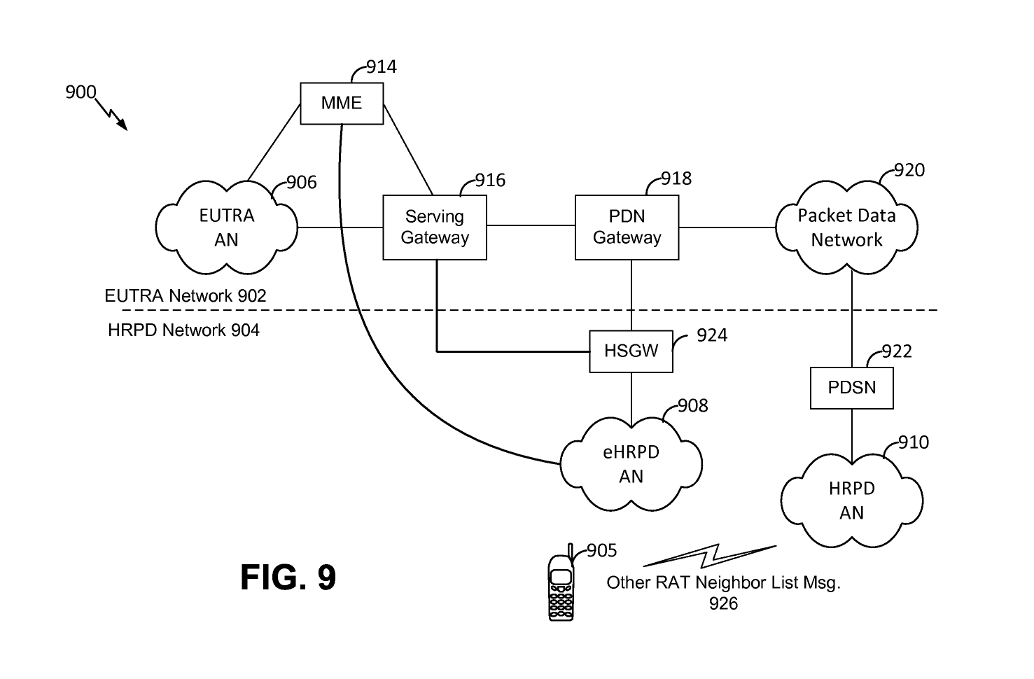

As previously mentioned, the aspects disclosed herein are directed towards expediting a UE reconfiguration to receive an eMBMS broadcast upon reselecting from a system that does not support eMBMS to a system that supports eMBMS. For instance, such reconfiguration may be desired when a UE transitions from HRPD operation to LTE operation. Referring next to FIG. 9, a conceptual block diagram 900 illustrating an exemplary environment in which such reselection may occur is provided. Here, wireless device 905 is capable of being operated in an E-UTRA network 902 (e.g., LTE) and an HRPD network 904, as shown. HRPD is defined by the CDMA 2000 standards, as established by 3GPP2. In some implementations, the migration from HRPD to E-UTRA may be provided by evolved HRPD (eHRPD) technology. A wireless device 905 that supports the eHRPD technology can be handed off between the eHRPD access network and an E-UTRA access network. Additionally, a wireless device 905 that supports eHRPD can perform cell reselection on either an E-UTRA access network or an eHRPD access network. In some aspects of the disclosure, a configuration message can be sent from an HRPD access network to the wireless device 905. One example of such configuration message is an Other RAT Neighbor List message which includes a list of neighboring cells with access technologies different from the access technology of the access network that the wireless device 905 is currently attached to.

As illustrated, the E-UTRA network 902 includes an E-UTRA access network 906, and the HRPD network 904 includes an enhanced HRPD (eHRPD) access network 908 and an HRPD access network 910. The eHRPD RAN 904 allows for interworking between the HRPD network 904 and the E-UTRA network 902. The E-UTRA network 902 also includes a serving gateway 916 and a mobility management entity (MME) 914. The MME 914 is a control node for the E-UTRA access network 906. For example, the MME 914 is responsible for idle mode mobile station tracking and paging procedures.

The E-UTRA network 902 also includes a serving gateway 916 and a PDN gateway 918. The serving gateway 916 routes bearer data packets and acts as a mobility anchor for the user plane during handovers between different access networks. The packet data network (PDN) gateway 918 provides connectivity between the wireless device 905 and the packet data network 920 (e.g., Internet). The wireless device 905 may connect wirelessly with the HRPD access network 910 which is connected to the packet data network 920 via a packet data serving node (PDSN) 922. The eHRPD access network 908 allows for interworking between the HRPD network 904 and the E-UTRA network 902. The eHRPD access network 908 is connected to an HRPD serving gateway (HSGW) 924. The HSGW 924 provides interworking of the wireless device 905 with the EUTRA network 902. When the wireless device 905 is camped on the HRPD network 904, it may receive an Other RAT Neighbor List message 926 from the HRPD access network 910.

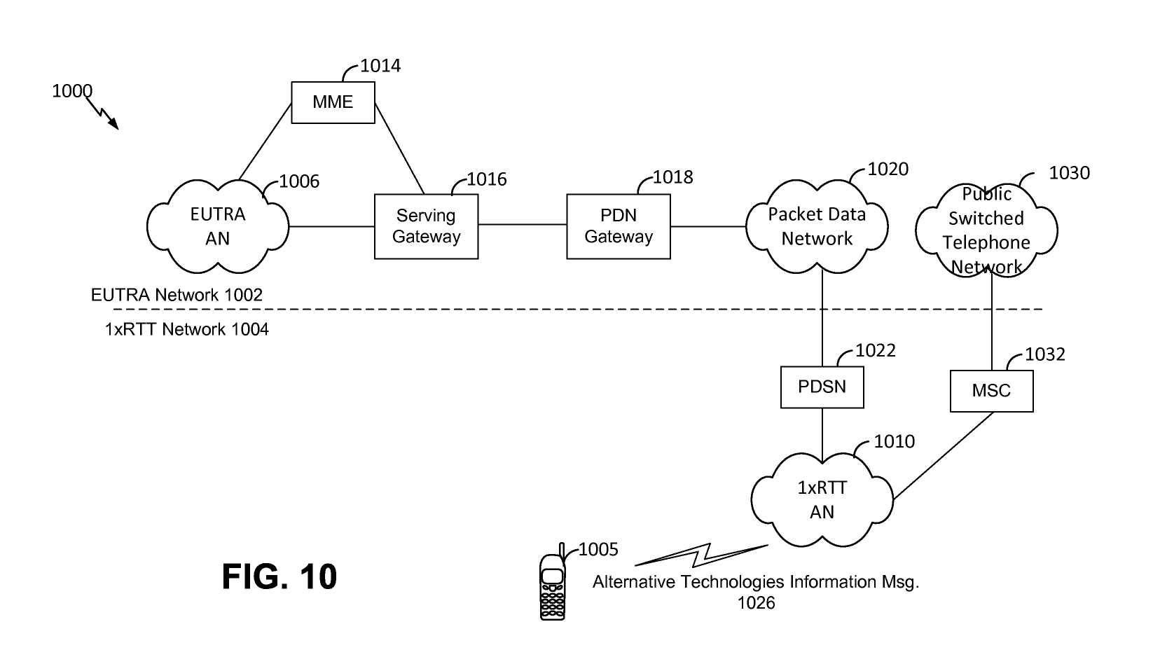

Referring next to FIG. 10, a conceptual block diagram 1000 illustrating an exemplary environment for reselecting from a 1xRTT network to an LTE system is provided. Here, it should be noted that 1xRTT elements illustrated in FIG. 10 are analogous to the HRPD elements illustrated in FIG. 9. Differences in functionality between these elements have been noted herein, as applicable to the subject disclosure.

Several aspects of a telecommunications system have been presented with reference to particular systems. As those skilled in the art will readily appreciate, various aspects described throughout this disclosure may be extended to other telecommunication systems, network architectures and communication standards.

By way of example, various aspects may be extended to other UMTS systems such as TD-SCDMA and TD-CDMA. Various aspects may also be extended to systems employing LTE (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first die may be coupled to a second die in a package even though the first die is never directly physically in contact with the second die. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-10 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-10 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; or c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication comprising:
operating a user equipment (UE) according to a first radio access technology (RAT), wherein the operating comprises utilizing an evolved multimedia broadcast multicast service (eMBMS) via the first RAT;
selecting a second RAT, wherein operation of the UE transitions from the first RAT to the second RAT, and wherein the second RAT is unable to support eMBMS; and
expediting a reselection of the first RAT, the expediting comprising modifying at least one of a dormancy timer value initialization, a reselection timer value initialization, or a frequency priority.

2. The method of claim 1, wherein the expediting is triggered upon detecting whether eMBMS middleware is currently enabled on the UE.

3. The method of claim 1, wherein the expediting is triggered upon detecting whether at least one eMBMS application is currently executing on the UE.

4. The method of claim 1, wherein the first RAT is a long term evolution (LTE) system.

5. The method of claim 1, wherein the second RAT is a high rate packet data (HRPD) system.

6. The method of claim 1, wherein the second RAT is a 1xRTT system.

7. The method of claim 1, wherein the dormancy timer value initialization is modified to a reduced value.

8. The method of claim 1, wherein the reselection timer value initialization is modified to a reduced value.

9. The method of claim 1, wherein the frequency priority is modified so that an eMBMS frequency is set to a higher priority.

10. The method of claim 9, wherein the frequency priority is modified based on instructions received from a network.

11. The method of claim 9, wherein the frequency priority is modified based on a previously used eMBMS frequency cached by the UE.

12. A device comprising:
a first circuit configured to operate a user equipment (UE) according to a first radio access technology (RAT), wherein the first circuit is configured to utilize an evolved multimedia broadcast multicast service (eMBMS) via the first RAT;
a second circuit configured to operate the UE according to a second RAT, wherein the device is configured to facilitate a UE transition from the first RAT to the second RAT, and wherein the second RAT is unable to support eMBMS; and
an expediting circuit configured to expedite a reselection of the first RAT, wherein the expediting circuit is configured to modify at least one of a dormancy timer value initialization, a reselection timer value initialization, or a frequency priority.

13. The device of claim 12, wherein the expediting circuit is configured to expedite the reselection based on whether eMBMS middleware is currently enabled on the UE.

14. The device of claim 12, wherein the expediting circuit is configured to expedite the reselection based on whether at least one eMBMS application is currently executing on the UE.

15. The device of claim 12, wherein the first RAT is a long term evolution (LTE) system.

16. The device of claim 12, wherein the second RAT is a high rate packet data (HRPD) system.

17. The device of claim 12, wherein the second RAT is a 1xRTT system.

18. The device of claim 12, wherein the expediting circuit is configured to modify the dormancy timer value initialization to a reduced value.

19. The device of claim 12, wherein the expediting circuit is configured to modify the reselection timer value initialization to a reduced value.

20. The device of claim 12, wherein the expediting circuit is configured to modify the frequency priority so that an eMBMS frequency is set to a higher priority.

21. The device of claim 20, wherein the expediting circuit is configured to modify the frequency priority based on instructions received from a network.

22. The device of claim 20, wherein the expediting circuit is configured to modify the frequency priority based on a previously used eMBMS frequency cached by the UE.

23. A device comprising:
means for operating a user equipment (UE) according to a first radio access technology (RAT), wherein the means for operating comprises means for utilizing an evolved multimedia broadcast multicast service (eMBMS) via the first RAT;
means for selecting a second RAT, wherein operation of the UE transitions from the first RAT to the second RAT, and wherein the second RAT is unable to support eMBMS; and
means for expediting a reselection of the first RAT, the means for expediting comprising means for modifying at least one of a dormancy timer value initialization, a reselection timer value initialization, or a frequency priority.

24. The device of claim 23, wherein the first RAT is a long term evolution (LTE) system.

25. The device of claim 23, wherein the second RAT is a high rate packet data (HRPD) system.

26. The device of claim 23, wherein the second RAT is a 1xRTT system.

27. A non-transitory machine-readable storage medium having one or more instructions stored thereon, which when executed by at least one processor causes the at least one processor to:
operate a user equipment (UE) according to a first radio access technology (RAT), wherein the UE utilizes an evolved multimedia broadcast multicast service (eMBMS) via the first RAT;
select a second RAT, wherein operation of the UE transitions from the first RAT to the second RAT, and wherein the second RAT is unable to support eMBMS; and
expedite a reselection of the first RAT by modifying at least one of a dormancy timer value initialization, a reselection timer value initialization, or a frequency priority.

28. The non-transitory machine-readable storage medium of claim 27, wherein the dormancy timer value initialization is modified to a reduced value.

29. The non-transitory machine-readable storage medium of claim 27, wherein the reselection timer value initialization is modified to a reduced value.

30. The non-transitory machine-readable storage medium of claim 27, wherein the frequency priority is modified so that an eMBMS frequency is set to a higher priority.
